(19) United States
(12) Patent Application Publication
(10) Pub. No.: US 2026/0148118 A1
(43) Pub. Date: May 28, 2026

(54) EVENT PREDICTION USING CONDITIONAL PROBABILITY MODELING

(71) Applicant: Optum Services (Ireland) Limited, Dublin (IE)

(72) Inventors: Laura Emily Brennan, Dublin (IE); Sinead Boyle, Donegal (IE); Dean Power, Dublin (IE); Shridhar Kulkarni, Dublin (IE)

(21) Appl. No.: 18/961,686

(22) Filed: Nov. 27, 2024

(51) Int. Cl. G06N 7/01; G06N 5/022

(52) U.S. Cl. CPC G06N 7/01; G06N 5/022

(57) ABSTRACT

Various embodiments of the present disclosure provide event prediction using conditional probability modeling that improves the functionality of a computer in various aspects. The techniques comprise receiving a request that identifies a class domain for an entity group, identifying a subset of the entity group that satisfies defined criterion associated with the class domain and an interval of time, determining a set of binary indicator data structures for respective entities of the subset based on the class domain and an entity data element set for the respective entities, applying a conditional probability model to the set of binary indicator vectors to determine an event score for a defined event associated with the entity group, and initiating the performance of a prediction-based action associated with the defined event based on the event score.

### BACKGROUND

Data systems that manage extensive datasets face efficiency (e.g., in terms of speed, accuracy, resource utilization) difficulties in efficiently extracting actionable insights and/or generating accurate predictions from complex, heterogeneous data sources. Traditionally, data-driven predictions may be provided using generalized data analysis techniques that provide generalized insights, but struggle to capture the full complexity of large datasets and/or account for nuanced differences between subgroups within a dataset. While powerful with respect to generalized predictions, generalized data analysis techniques lack the ability to adapt to dynamic data conditions in real time. This lack of adaptability traditionally necessitates multiple, different model for analyzing different data types, such as temporally and non-temporally related data. For instance, generalized data analysis techniques are inefficient when analyzing complex, multi-modal interdependencies between variables, or produce results that are difficult to interpret or apply in practical decision-making contexts.

Various embodiments of the present disclosure make important contributions to data analysis and predictive modeling technologies by addressing these technical challenges, among others.

### BRIEF DESCRIPTION OF THE DRAWINGS

FIG. 1 depicts an example overview of an architecture in accordance with some embodiments of the present disclosure.

FIG. 2 depicts an example predictive data analysis computing entity in accordance with some embodiments of the present disclosure.

FIG. 3 depicts an example client computing entity in accordance with some embodiments of the present disclosure.

FIG. 4 depicts a dataflow diagram showing example data structures, modules, and/or pipelines for implementing data vectorization in accordance with some embodiments of the present disclosure.

FIG. 5 depicts a dataflow diagram showing example data structures, modules, and/or pipelines for providing conditional probability modeling in accordance with some embodiments of the present disclosure.

FIG. 6 depicts an interactive visualization system showing example devices, systems, engines, data structures, and/or processes for generating one or more user interface elements for rendering via a user interface in accordance with some embodiments of the present disclosure.

FIG. 7 depicts an example system for providing prediction-based actions and/or visualizations in accordance with some embodiments of the present disclosure.

FIG. 8 depicts example user interface in accordance with some embodiments of the present disclosure.

FIG. 9 depicts a flowchart diagram of example process for implementing conditional probability modeling in accordance with some embodiments of the present disclosure.

### DETAILED DESCRIPTION

Various embodiments of the present disclosure provide an optimized predictive data analytics system that integrate conditional probability techniques with new data modeling architectures to enable interactive analysis of data within complex, multi-modal class domains. For example, traditional predictive data analysis systems face several technical challenges in balancing prediction speed, processing efficiency, and prediction accuracy for predictions in high-dimensional categorical feature spaces with a high degree of cardinality. In various embodiments, a predictive data analytics pipeline of the present disclosure addresses these challenges by synthesizing labels for time events associated with a subclass domain of a class domain for an entity group into a set of binary indicator data structures. In some embodiments of the present disclosure, the predictive data analytics pipeline provides event scores for defined events using a conditional probability model that receives the set of binary indicator data structures as input. To overcome performance deficiencies with traditional predictive data analysis systems, the set of binary indicator data structures enable vectorization of data associated with high-dimensional categorical feature spaces and/or a high degree of cardinality in accordance with one or more performance rules for optimizing performance of the conditional probability model. The set of binary indicator data structures may also provide fine-grained data points to enable more efficient processing, a lower number of computing resources, and/or more flexible data processing of complex data.

In some embodiments, the set of binary indicator data structures enable real-time processing of a request (e.g., a query or another type of user-defined request) received via a user interface by reducing an amount of time required for processing complex data associated with high-dimensional categorical feature spaces and/or a high degree of cardinality. In this way, the conditional probability model provides more accurate predictions via improved optimized predictive data analytics that addresses various technical deficiencies of traditional predictive data analysis systems. When applied within a user interface environment, the set of binary indicator data structures and/or the conditional probability model enable an improved user interface that may be leveraged to automate various computer-based actions. In some embodiments, the set of binary indicator data structures and/or the conditional probability model enable efficient and reliable processing of user interface workflows in real time while also providing efficient and reliable recommendations visualizations related to prediction results via a user interface. In some embodiments, a user interface workflow and/or a user interface request initiated via a user interface may be resolved in a shorter amount of time and/or by utilizing fewer computing resources as compared to traditional user interfaces. Additionally, or alternatively, visualizations related to the user interface may be rendered in a shorter amount of time and/or by utilizing fewer computing resources as compared to traditional user interfaces.

In some embodiments, the predictions provided by the conditional probability model pipeline (e.g., by utilizing the set of binary indicator data structures and/or the conditional probability model) enable a degree of accuracy and/or types of insights that has traditionally been outside the scope of traditional predictive data analysis systems. For instance, the conditional probability model pipeline may be configured to predict relationships between labels of binary indicator data structures and a set of defined events to determine a predicted probability for one or more defined events related to data, where the labels provide fine-grained attributes of the data. In some embodiments, the conditional probability model pipeline is integrated with a user interface to enable interactive actions based on insights provided by the conditional probability model. By doing so, the conditional probability model may enable accurate insights from dense feature-level data that may be efficiently processed with limited computing resources to augment a user interface in accordance with insights provided by the conditional probability model. In this way, the conditional probability model pipeline integrated within the user interface may enable real-time user interface renderings and/or automated computer-based actions without sacrificing the predictive accuracy of insights that are traditionally diluted using traditional predictive data analysis systems.

In some embodiments, improved data pre-processing techniques for modeling are provided to improve input data and/or matching operations in high-dimensional computing systems that utilize modeling. By doing so, the data pre-processing may enable improved modeling processes that, when executed on a computer, improve computing resources and/or functionality of a computer with respect to various computing tasks, comprising model execution, network communication, user interface rendering, and/or the like. In some embodiments, a data processing pipeline that utilizes machine learning to ingest, aggregate, manage, and/or transform data from data sources into one or more binary indicator data structures. In some embodiments, the data processing pre-processing intelligently configures data for a particular modeling task such as a conditional probability task and/or an API task for a user interface. The resulting data provided by the modeling task may then be contextualized and/or formatted for rendering via an interactive user interface rendering. This, in turn, enables improved data pre-processing for a model (e.g., a conditional probability model) that directly addresses technical challenges within the realm of traditional predictive data analysis systems, such as time-consuming ingestion of data, resource intensive transformation of data, and/or inaccurate datasets for modeling tasks, among others.

In an example related to a healthcare technology domain, some embodiments provide optimized reduction in medical events associated with increased medication adherence by synthesizing claims data into a set of binary indicator data structures provided as input to a conditional probability model. For example, a predicted degree and/or type of medication to achieve a specific medical output may be provided by synthesizing claims data into a set of binary indicator data structures provided as input to a conditional probability model. Accordingly, more precise and/or data-driven predictions for patients may be provided. This, in turn, enables optimized prediction-based actions that, unlike traditional techniques, account for nuanced feature-level characteristics within a limited dataset for different patient groups. Additionally, by utilizing improved conditional probability modeling and advanced data scaling techniques, more accurate predictions from limited sample data may be provided, facilitating improved intervention optimization across patient groups.

Examples of technologically advantageous embodiments of the present disclosure comprise (i) improved predictive data analytics systems, (ii) improved data modeling frameworks, (iii) improved data vectorization techniques, (iv) improved data processing techniques such as data pre-processing techniques for improving data formatting of input data for modeling, (v) improved conditional probability modeling techniques for optimizing predictive output, and (vi) improved user interfaces and/or data visualizations by optimizing a data object for a rendering of a data visualization via a user interface, among other aspects of the present disclosure. Other technical improvements and advantages may be realized by one of ordinary skill in the art.

### I. Overview of Embodiments

As should be appreciated, various embodiments of the present disclosure may be implemented as methods, apparatus, systems, computing devices, computing entities, computer program products, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may take the form of an entirely hardware embodiment, an entirely computer program product embodiment, and/or an embodiment that comprises a combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments may produce specifically configured machines performing the steps or operations specified in the block diagrams and flowchart illustrations. Accordingly, the block diagrams and flowchart illustrations support various combinations of embodiments for performing the specified instructions, operations, or steps.

### II. Example Framework

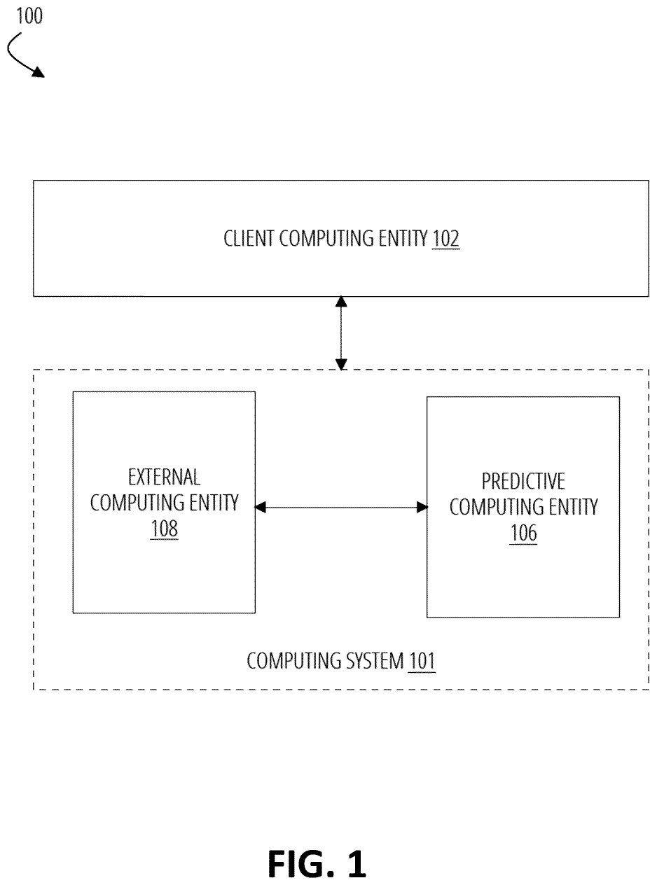

FIG. 1 depicts an example overview of an architecture 100 in accordance with some embodiments of the present disclosure. The architecture 100 comprises a computing system 101 configured to receive a request, such as a user interface request, a conditional probability modeling request, a large language model prompt request, and/or the like, from client computing entities 102, process the request, and provide one or more responses, such as model output, prediction output, a data visualization, one or more graphical elements, a user interface overlay, and/or the like to the client computing entities 102. The example architecture 100 may be used in a plurality of domains and not limited to any specific application as disclosed herewith. The plurality of domains may comprise healthcare, industrial, manufacturing, computer security, and/or the like to name a few.

In accordance with various embodiments of the present disclosure, one or more machine learned models may be trained to generate candidate outputs, candidate output scores, labels, binary indicator data structures, and/or other machine learned outputs. The models may be adapted to a differential request handling engine and/or complementary scoring mechanism that may collectively process a request using data scaling and/or data pre-processing. Some techniques of the present disclosure may adapt traditional models to a cohesive modeling framework for more efficiently handling portions of the request handling process.

In some embodiments, the computing system 101 communicates with at least one of the client computing entities 102 using one or more communication networks. Examples of communication networks comprise any wired or wireless communication network comprising, for example, a wired or wireless local area network (LAN), personal area network (PAN), metropolitan area network (MAN), wide area network (WAN), or the like, as well as any hardware, software, and/or firmware required to implement it (such as, e.g., network routers, and/or the like).

The computing system 101 may comprise a predictive computing entity 106 and one or more external computing entities 108. The predictive computing entity 106 and/or one or more external computing entities 108 may be individually and/or collectively configured to receive requests from client computing entities 102, process the requests to generate code predictions, and provide the code predictions to the client computing entities 102.

For example, as discussed in further detail herein, the predictive computing entity 106 and/or one or more external computing entities 108 comprise storage subsystems that may be configured to store input data, training data, and/or the like that may be used by the respective computing entities to perform predictive data analysis and/or training operations of the present disclosure. In addition, the storage subsystems may be configured to store model definition data used by the respective computing entities to perform various predictive data processing and/or training tasks. The storage subsystem may comprise one or more storage units, such as multiple distributed storage units that are connected through a computer network. A storage unit in the respective computing entities may store at least one of one or more data assets and/or a set of data about the computed properties of one or more data assets. Moreover, each storage unit in the storage systems may comprise one or more non-volatile storage or volatile storage media similar to or different than the non-volatile and/or volatile computer-readable storage media discussed above.

In some embodiments, the predictive computing entity 106 and/or one or more external computing entities 108 are communicatively coupled using one or more wired and/or wireless communication techniques. The respective computing entities may be configured according to the techniques described herein to perform one or more operations of one or more techniques described herein. By way of example, the predictive computing entity 106 may be configured to train, implement, use (e.g., execute an inference operation(s)), update (e.g., fine-tune), and/or evaluate conditional probability models in accordance with one or more training and/or inference operations of the present disclosure. In some examples, the external computing entities 108 may be configured to train, implement, use, update, and/or evaluate conditional probability models in accordance with one or more training and/or inference operations of the present disclosure.

In some example embodiments, the predictive computing entity 106 may be configured to receive and/or transmit one or more datasets, objects, and/or the like from and/or to the external computing entities 108 to perform one or more steps/operations of one or more techniques (e.g., request handling, conditional probability modeling techniques, scoring techniques, etc.) described herein. The external computing entities 108, for example, may comprise and/or be associated with one or more entities that may be configured to receive, transmit, store, manage, and/or facilitate datasets, and/or the like. The external computing entities 108, for example, may comprise data sources that may provide such datasets, and/or the like to the predictive computing entity 106 which may leverage the datasets, such as one or more recorded entity cohorts and/or the like, to perform one or more steps/operations of the present disclosure, as described herein. In some examples, the datasets may comprise an aggregation of data from across a plurality of external computing entities 108 into one or more aggregated datasets. The external computing entities 108, for example, may be associated with one or more data repositories, cloud platforms, compute nodes, organizations, and/or the like, which may be individually and/or collectively leveraged by the predictive computing entity 106 to obtain and aggregate data for an information domain.

In some example embodiments, the predictive computing entity 106 may be configured to receive a trained model trained and subsequently provided by the one or more external computing entities 108. For example, the one or more external computing entities 108 may be configured to perform one or more training steps/operations of the present disclosure to train a model, as described herein. In such a case, the trained model may be provided to the predictive computing entity 106, which may leverage the trained model to perform one or more inference steps/operations of the present disclosure. In some examples, feedback (e.g., evaluation data, ground truth data) from the use of the model may be received and/or stored by the predictive computing entity 106. In some examples, the feedback may be provided to the one or more external computing entities 108 to continuously train the model over time. In some examples, the feedback may be leveraged by the predictive computing entity 106 to continuously train the model over time. In this manner, the computing system 101 may perform, via one or more combinations of computing entities, one or more prediction, training, and/or any other modeling techniques of the present disclosure.

### A. Example Predictive Computing Entity

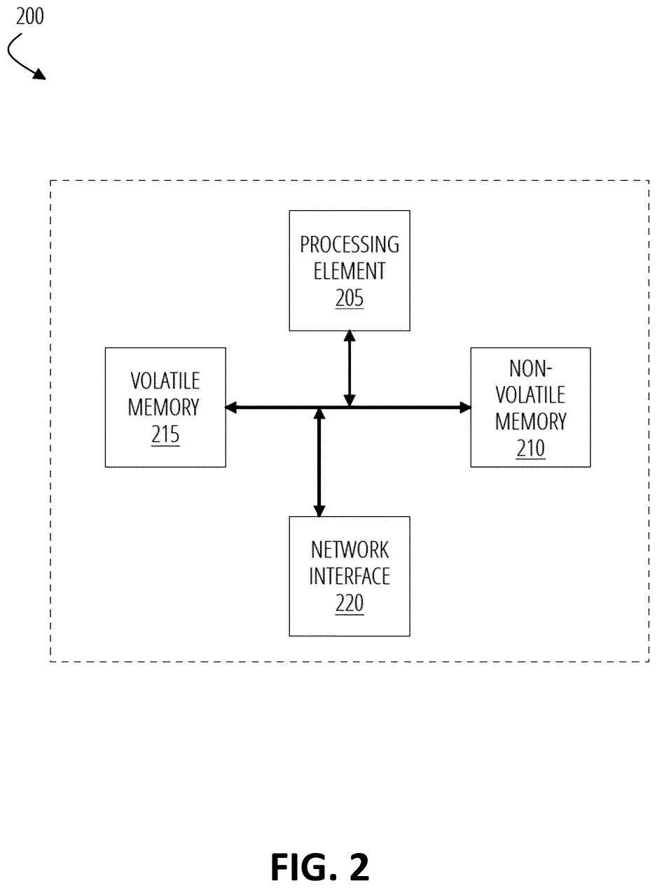

FIG. 2 depicts an example computing entity 200 in accordance with some embodiments of the present disclosure. The computing entity 200 is an example of the predictive computing entity 106 and/or external computing entities 108 of FIG. 1. In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may comprise, for example, transmitting, receiving, operating on, processing, displaying, storing, determining, creating/generating, training one or more machine learning models, monitoring, evaluating, comparing, and/or similar terms used herein interchangeably. In some embodiments, these functions, operations, and/or processes may be performed on data, content, information, and/or similar terms used herein interchangeably. In some embodiments, the one computing entity (e.g., predictive computing entity 106) may train and use one or more machine learning models described herein. In other embodiments, a first computing entity (e.g., predictive computing entity 106, which may be one or more predictive computing entities) may use one or more machine learning models that may be trained by a second computing entity (e.g., external computing entity 108) communicatively coupled to the first computing entity. The second computing entity, for example, may train one or more of the machine learning models described herein, and subsequently provide the trained machine learning model(s) (e.g., optimized weights, code sets) to the first computing entity over a network.

As shown in FIG. 2, in some embodiments, the computing entity 200 may comprise, or be in communication with, one or more processing elements 205 (also referred to as processors, processing circuitry, and/or similar terms used herein interchangeably) that communicate with other elements within the computing entity 200 via a bus, for example. As will be understood, the processing element 205 may be embodied in a number of different ways.

For example, the processing element 205 may be embodied as one or more complex programmable logic devices (CPLDs), microprocessors, multi-core processors, arithmetic logic units (ALUs) (e.g., which may be part of one or more graphics processing units (GPUs), tensor processing units (TPUs), and/or the like), coprocessing entities, application-specific instruction-set processors (ASIPs), microcontrollers, and/or controllers. Additionally, or alternatively, the processing element 205 may be embodied as one or more other processing devices and/or circuitry. The term circuitry may refer to an entirely hardware embodiment or a combination of hardware and computer program products. Examples of a combination of hardware and computer program products comprise application specific integrated circuits (ASICs), field programmable gate arrays (FPGAs), programmable logic arrays (PLAs), hardware accelerators, other circuitry, and/or the like.

As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present disclosure when configured accordingly.

In some embodiments, the computing entity 200 may further comprise, or be in communication with, non-transitory computer readable media, such as non-volatile memory 210 (also referred to as non-volatile media, storage, memory storage, memory circuitry, and/or similar terms used herein interchangeably) and/or volatile memory 215 (also referred to as volatile media, storage, memory storage, memory circuitry, and/or similar terms used herein interchangeably), as discussed above.

In some embodiments, non-volatile memory 210 may comprise a computer-readable storage medium may comprise a floppy disk, flexible disk, hard disk, solid-state storage (SSS) (e.g., a solid-state drive (SSD), solid-state card (SSC), solid-state module (SSM)), enterprise flash drive, magnetic tape, or any other non-transitory magnetic medium, and/or the like. A non-volatile computer-readable storage medium may also comprise a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also comprise read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also comprise conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In some embodiments, volatile memory 215 may comprise a computer-readable storage medium comprising random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (comprising various levels), flash memory, register memory, and/or the like. It will be appreciated that where embodiments are described to use a computer-readable storage medium, other types of computer-readable storage media may be substituted for or used in addition to the computer-readable storage media described above.

As will be recognized, the non-volatile memory 210 and/or the volatile memory 215 may store respective part(s) of one or more databases, database instances, database management systems, data, applications, programs, program modules, scripts, code (e.g., source code, object code, byte code, compiled code, interpreted code, machine code) that embodies one or more machine learning models or other computer functions described herein, executable instructions, and/or the like being executed by, for example, the processing element 205. The term database, database instance, database management system, and/or similar terms used herein interchangeably, may refer to a collection of records or data that is stored in a computer-readable storage medium using one or more database models; such as a hierarchical database model, network model, relational model, entity-relationship model, object model, document model, semantic model, graph model, and/or the like.

Thus, the databases, database instances, database management systems, data, applications, programs, program modules, code (source code, object code, byte code, compiled code, interpreted code, machine code) that embodies one or more machine learning models or other computer functions described herein, executable instructions, and/or the like may be used to control certain aspects of the operation of the computing entity 200 by operating the processing element 205 according to software component(s) retrieved from any of the computer-readable storage media and executed by the processing element 205.

Embodiments of the present disclosure may be implemented in various ways, comprising as computer program products that comprise articles of manufacture. Such computer program products may comprise one or more software components comprising, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages comprise, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form, such as object code, or may be first transformed into another form, such as by compiling source code. A software component may be stored as a file or other data storage construct. Software components of a similar type or functionally related may be stored together such as in a particular directory, folder, or library. Software components may be static (e.g., pre-established, or fixed) or dynamic (e.g., created or modified at the time of execution).

A computer program product may comprise a non-transitory computer-readable storage medium storing one or more software components comprising application(s), program(s), program module(s), script(s), source code and/or compiler(s) for generating executable instructions such as object code using the source code, program code, object code, byte code, compiled code, interpreted code, machine code, executable instructions, and/or the like (e.g., executable instructions, instructions for execution, computer program products, program code, and/or similar terms used herein interchangeably). Such non-transitory computer-readable storage media comprise all computer-readable storage media (comprising volatile memory 215 and non-volatile memory 210). In some embodiments, the computer program product may be executed by the computing entity 200 and/or the client computing entity. For example, at least a first portion of the computer program product may be stored within the volatile memory 215 and/or non-volatile 210 of the computing entity 200. In addition, or alternatively, at least a second portion of the computer program product may be stored within the volatile and/or non-volatile memory of a client computing entity.

As indicated, in some embodiments, the computing entity 200 may also comprise one or more network interfaces 220 for communicating with various computing entities (e.g., the client computing entity 102, external computing entities), such as by communicating data, code, content, information, and/or similar terms used herein interchangeably that may be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. In some embodiments, the computing entity 200 communicates with another computing entity for uploading or downloading data or code (e.g., data or code that embodies or is otherwise associated with one or more machine learning models). Similarly, the computing entity 200 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, IEEE 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the computing entity 200 may in addition or alternatively comprise, or be in communication with, one or more input elements/devices, such as input sensor(s). In some examples, the input sensor(s) may comprise one or more keyboards, pointing devices (e.g., mouse, trackpad), touch screens, cameras (e.g., infrared light camera, visual light camera), depth sensors (e.g., LIDAR, radar, stereo cameras), gyroscopes, location sensors (e.g., global positioning system (GPS), Hall effect sensor, laser doppler vibrometer), microphones, and/or the like. The computing entity 200 may in addition or alternatively comprise, or be in communication with, one or more output elements/devices (not shown), such as one or more speakers, visual display devices, haptic feedback devices, motion devices (e.g., electromechanically actuated devices), and/or the like.

### B. Example Client Computing Entity

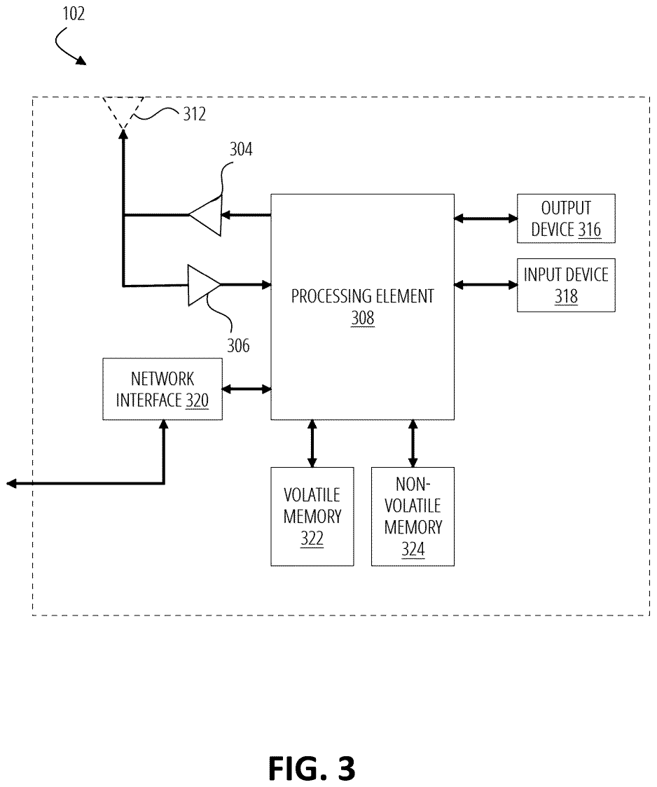

FIG. 3 depicts an example client computing entity in accordance with some embodiments of the present disclosure. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Client computing entities 102 may be operated by various parties. As shown in FIG. 3, the client computing entity 102 may comprise an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) that provides signals to and receives signals from the transmitter 304 and receiver 306, correspondingly.

The signals provided to and received from the transmitter 304 and the receiver 306, correspondingly, may comprise signaling information/data in accordance with air interface standards of applicable wireless systems. In this regard, the client computing entity 102 may be capable of operating with one or more air interface standards, communication protocols, modulation types, and access types. More particularly, the client computing entity 102 may operate in accordance with one or more wireless and/or wired communication standards and protocols, such as those described above with regard to the computing entity 200.

The client computing entity 102 may in addition or alternatively download code, changes, add-ons, and updates, for instance, to its firmware, software (e.g., comprising executable instructions, applications, program modules), and operating system.

According to some embodiments, the client computing entity 102 may comprise location determining aspects, devices, modules, functionalities, and/or similar words used herein interchangeably. For example, the client computing entity 102 may comprise outdoor positioning aspects, such as a location component adapted to acquire, for example, latitude, longitude, altitude, geocode, course, direction, heading, speed, universal time (UTC), date, and/or various other information/data. In some embodiments, the location component may acquire data, sometimes known as ephemeris data, by identifying the number of satellites in view and the relative positions of those satellites (e.g., using global positioning systems (GPS)). The satellites may be a variety of different satellites, comprising Low Earth Orbit (LEO) satellite systems, Department of Defense (DOD) satellite systems, the European Union Galileo positioning systems, the Chinese Compass navigation systems, Indian Regional Navigational satellite systems, and/or the like. This data may be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data may be determined by triangulating the position of the client computing entity 102 in connection with a variety of other systems, comprising cellular towers, Wi-Fi access points, and/or the like. Similarly, the client computing entity 102 may comprise indoor positioning aspects, such as a location component adapted to acquire, for example, latitude, longitude, altitude, geocode, course, direction, heading, speed, time, date, and/or various other information/data. Some of the indoor systems may use various position or location technologies comprising RFID tags, indoor beacons or transmitters, Wi-Fi access points, cellular towers, nearby computing devices (e.g., smartphones, laptops), and/or the like. For instance, such technologies may comprise the iBeacons, Gimbal proximity beacons, Bluetooth Low Energy (BLE) transmitters, NFC transmitters, and/or the like. These indoor positioning aspects may be used in a variety of settings to determine the location of someone or something to within inches or centimeters.

The client computing entity 102 may also comprise a user interface that may comprise an output device 316 coupled to a processing element 308 and/or a user input device 318 coupled to the processing element 308. An output device 316, for example, may comprise a hardware computing device comprising one or more output elements (not shown), such as one or more speakers, visual display devices, haptic feedback devices, motion devices (e.g., electromechanically actuated devices), and/or the like. A user input device 318 may comprise the same or different hardware computing device comprising one or more input elements (not shown), such as keyboards, pointing devices (e.g., mouse, trackpad), touch screens, cameras (e.g., infrared light camera, visual light camera), depth sensors (e.g., LIDAR, radar, stereo cameras), gyroscopes, location sensors (e.g., global positioning system (GPS), Hall effect sensor, laser doppler vibrometer), microphones, and/or the like.

In some examples, the user interface may in addition or alternatively comprise software component(s) executed by the processing element 308 to present (e.g., audibly, visually, tactilely) via a user input device 318 and/or output device 316 and/or a software endpoint such as an application programming interface (API) or exposed software function a graphical user interface (GUI) (e.g., at least a portion of a user application, browser), command-line interface, touch and/or haptic user interface, gesture and/or image capture-based interface, voice/audio user interface, and/or the like used herein interchangeably executing on and/or accessible via the client computing entity 102 to interact with and/or cause display of information/data from the computing entity 200, as described herein. In addition to providing input, the user input interface may be used, for example, to activate, deactivate, and/or modify certain functions, such as altering a power or operating state of the client computing entity 102, the computing system 101, the predictive computing entity 106, and/or the external computing entity 108.

The client computing entity 102 may further comprise, or be in communication with, one or more memory components, such as the volatile memory 322 and/or non-volatile memory 324. For example, the memory components may comprise non-transitory computer readable media, such as non-volatile memory 324 (also referred to as non-volatile storage, memory, memory storage, memory circuitry, and/or similar terms used herein interchangeably) and/or volatile memory 322 (also referred to as volatile storage, memory, memory storage, memory circuitry, and/or similar terms used herein interchangeably), as discussed above with reference to FIG. 2.

As will be recognized, the non-volatile memory 324 and/or the volatile memory 322 may store respective part(s) of one or more databases, database instances, database management systems, data, applications, programs, program modules, scripts, code (e.g., source code, object code, byte code, compiled code, interpreted code, machine code) that embodies one or more machine learning models or other computer functions described herein, executable instructions, and/or the like being executed by, for example, the processing element 308. The term database, database instance, database management system, and/or similar terms used herein interchangeably, may refer to a collection of records or data that is stored in a computer-readable storage medium using one or more database models; such as a hierarchical database model, network model, relational model, entity-relationship model, object model, document model, semantic model, graph model, and/or the like.

In another embodiment, the client computing entity 102 may comprise one or more components or functionalities that are the same or similar to those of the computing entity 200, as described in greater detail above. In one such embodiment, the client computing entity 102 downloads, e.g., via network interface 320, code embodying machine learning model(s) from the computing entity 200 so that the client computing entity 102 may run a local instance of the machine learning model(s). As will be recognized, these architectures and descriptions are provided for example purposes only and are not limited to the various embodiments.

In various embodiments, the client computing entity 102 may be embodied as an artificial intelligence (AI) computing entity (e.g., an intelligent agent machine-learned model), such as AutoGPT, Mycroft, Rhasspy, and/or the like. Accordingly, the client computing entity 102 may be configured to provide and/or receive information/data from a user via an input/output mechanism, such as a display, a camera, a speaker, a voice-activated input, and/or the like. In certain embodiments, an AI computing entity may comprise one or more predefined and executable program algorithms stored within an onboard memory storage component, and/or accessible over a network. In various embodiments, the AI computing entity may be configured to retrieve and/or execute one or more of the predefined program algorithms upon the occurrence of a predefined trigger event.

### III. Example System Operations

As indicated, various embodiments of the present disclosure make important technical contributions to optimizing predictive data analytics system systems by providing improved data modeling and/or conditional probability techniques to enable interactive analysis of data for complex class domains. To overcome performance deficiencies with traditional predictive data analysis systems, various embodiments generate and utilize a set of binary indicator data structures to improve performance of a conditional probability model. In various embodiments, a predictive data analytics pipeline synthesizes labels for time events associated with a subclass domain of a class domain for an entity group into a set of binary indicator data structures. Additionally, the predictive data analytics pipeline provides event scores for defined events using a conditional probability model that receives the set of binary indicator data structures as input. To overcome performance deficiencies with traditional predictive data analysis systems, the set of binary indicator data structures enable vectorization of data associated with high-dimensional categorical feature spaces and/or a high degree of cardinality in accordance with one or more performance rules for optimizing performance of the conditional probability model. The set of binary indicator data structures may also provide fine-grained data points to enable more efficient processing, a lower number of computing resources, and/or more flexible data processing of complex data.

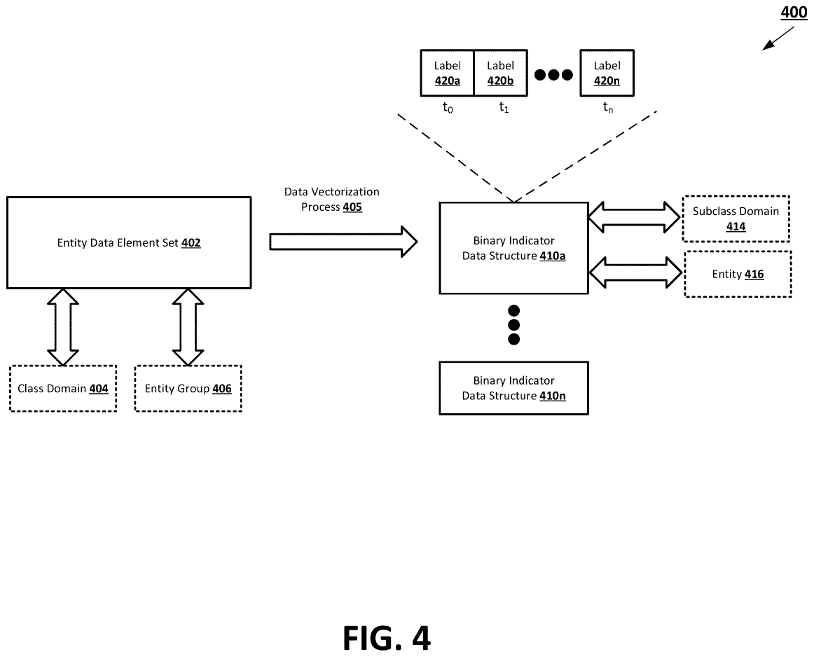

FIG. 4 depicts a dataflow diagram 400 showing example data structures, modules, and/or pipelines for implementing data vectorization in accordance with some embodiments discussed herein. In some embodiments, the dataflow diagram 400 provides a pre-processing stage for a conditional probability model that utilizes data vectorization to generate one or more binary indicator data structures. The dataflow diagram 400 may provide improved input for the conditional probability model to enable more accurate predictions from complex data. The dataflow diagram 400 comprises a data vectorization process 405 that synthesizes an entity data element set 402 into a set of binary indicator data structures 410a-n. In some embodiments, the computing system 101 performs the data vectorization process 405. The entity data element set 402 may be associated with a class domain 404 and an entity group 406. The entity group 406 may comprise a plurality of entities associated with the class domain 404. In some embodiments, the class domain 404 may be determined based on a request that identifies the class domain 404 for the entity group 406. The class domain 404 may correspond to a particular class, classification, or other type of data identifier for a data analysis task. In some embodiments, the class domain 404 may correspond to a disease domain (e.g., a diagnosis of a condition) such as an atrial fibrillation diagnosis. In some embodiments, the disease domain may leverage medical diagnoses to identify defined health conditions and/or other features predictive of patient outcomes. For instance, a disease domain may utilize an atrial fibrillation diagnosis to classify patients for analysis of medication adherence and/or likelihood of hospitalization. In some embodiments, the request is generated responsive to user input via a user interface of a client device. In some embodiments, the user input identifies the class domain and the interval of time. In some embodiments, the request is a query provided to a large language model.

In some embodiments, the entity group 406 refers to a member population of interest M. For example, the entity group 406 may comprise a group of entities that share a common characteristic and/or condition relevant to the class domain 404. In some embodiments, the entity group 406 may be a patient population that has been diagnosed with a particular medical condition (e.g., an atrial fibrillation diagnosis). Members m E M of the entity group may be those individuals who have a previous diagnosis of the medical condition that is a prerequisite to prescription for medications of interest related to treating or managing the medical condition.

In some embodiments, the entity data element set 402 may comprise a plurality of entity data elements. For example, an entity data element may be a data construct that describes a collection of text data for an entity. In some embodiments, an entity data element may correspond to a medical record (e.g., a medical claim). A medical record (e.g., typically multiple pages) may contain information for all claim lines in a case. A portion of a medical record for a particular claim line may be one paragraph or a set of keywords in the medical record. In some embodiments, an entity data element may comprise data associated with diagnoses, procedures, medications, and/or other medical utilization patterns over time. In some embodiments, an entity data element may comprise one or more predictive codes. A predictive code may refer to a data construct that describes an identifier for one or more tasks, one or more services, and/or one or more actions related to the entity data element. In some embodiments, a predictive code may be a medical code employed to report one or more tasks, one or more services, and/or one or more actions related to a medical record. For example, in certain embodiments, a predictive code may be a CPT code, a DX code, an RX code, a Logical Observation Identifier Names and Codes (LOINC) code, or another type of predictive code.

The computing system 101 generates the set of binary indicator data structures 410a-n based on the entity data element set 402 via the data vectorization process 405. In some embodiments, the computing system 101 may receive a request that identifies the class domain 404 for the entity group 406. Additionally, the computing system 101 may identify a subset of the entity group 406 that satisfies defined criterion associated with the class domain 404 and/or an interval of time. In some embodiments, the request may further identify the interval of time. The interval of time may indicate a time period of interest for the entity data element set 402. In some embodiments, the computing system 101 may generate a first binary indicator data structure associated with a first type of event within the entity data element set, a second binary indicator data structure associated with a second type of event within the entity data element set, and/or a third binary indicator data structure associated with a third type of event within the entity data element set. In some embodiments, the computing system 101 may determine the set of binary indicator data structures 410a-n for respective entities of the subset of the entity group 406 based on the class domain 404 and a respective portion of the entity data element set 402 for the respective entities. In some embodiments, the subset of the entity group 406 may refer to a subset of the member population. In some embodiments, the subset of the entity group 406 may comprise any subgroup of entities within the entity group 406 that meets specific criteria relevant to the analysis being performed. For example, the subset of the entity group 406 may be an opportunity population U S M for the class domain 404, where U represents a subgroup of members from the larger population M that satisfies certain conditions and/or characteristics of interest. In some embodiments, the computing system 101 may determine the entity group 406 based on a clustering model associated with a set of similarity rules for the entity group 406. The set of similarity rules may be associated with one or more features, attributes, and/or other characteristics that distinguish the entity group 406 from one or more other types of entity groups.

The set of binary indicator data structures 410a-n may respectively comprise a label set associated with an entity of the entity group 406, respective timepoints of the interval of time, and/or a subclass domain of the class domain 404. For example, a binary indicator data structure 410a of the set of binary indicator data structures 410a-n may be associated with a subclass domain 414 of the class domain 404. The binary indicator data structure 410a may be additionally associated with an entity 416 of the entity group 406. In some embodiments, the binary indicator data structure 410a may comprise a label set 420a-n associated with the subclass domain 414 and the entity 416. Respective labels of the label set 420a-n may also be associated with a respective timepoint of the interval of time. For example, a label 420a of the label set 420a may be associated with a label for data associated with the entity data element set 402 that corresponds to a timepoint t₀ of the interval of time t₀-tₙ, the subclass domain 414, and the entity 416. Additionally, a label 420b of the label set 420a may be associated with a label for data associated with the entity data element set 402 that corresponds to a timepoint t₁ of the interval of time, the subclass domain 414, and the entity 416, etc. A timepoint may refer to a time element t of a period of interest T. In some embodiments, a time event may comprise a discrete point of time within the interval of time that is relevant to the analysis being performed. For example, a timepoint may be a specific day within a 6-month interval of time. A label of the label set 420a-n may capture a binary state related to a time-specific attribute, feature, and/or event for a portion of the entity data element set 402 associated with the subclass domain 414.

In some embodiments, a first binary indicator data structure for an entity (e.g., the entity 416) may be associated with a first type of event within the entity data element set 402. Additionally, a second binary indicator data structure for the entity (e.g., the entity 416) may be associated with a second type of event within the entity data element set 402. In some embodiments, a third binary indicator data structure for the entity (e.g., the entity 416) may be associated with a third type of event within the entity data element set 402. In some embodiments, the first binary indicator data structure is a first type of binary indicator data structure i(t) that indicates if member m has had an inpatient admissions event on a particular day t, the second binary indicator data structure is a second type of binary indicator data structure s(t) that indicates if member m was adequately medicated on the particular day t, and the third binary indicator data structure is a third type of binary indicator data structure a(t) that indicates if member m was active and enrolled on the particular day t. However, it is to be appreciated that, in some embodiments, a different number and/or different type of binary indicator data structures may be generated for an entity (e.g., the entity 416).

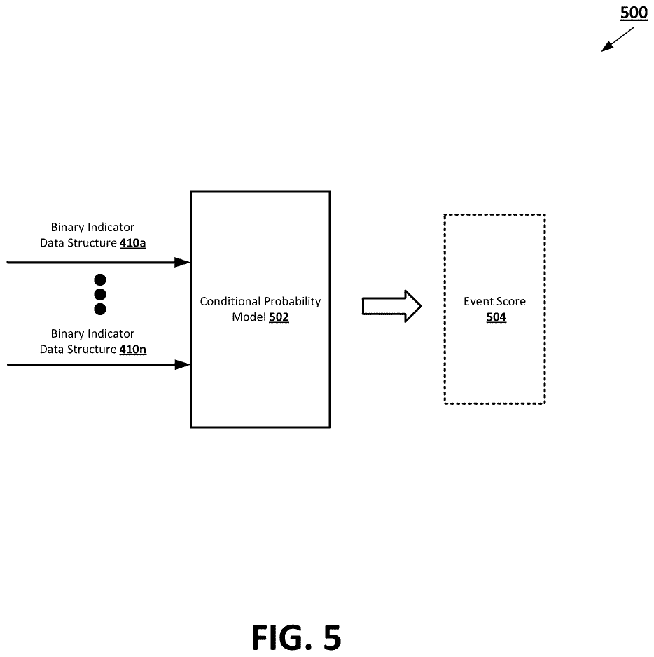

FIG. 5 depicts a dataflow diagram 500 showing example data structures, modules, and/or pipelines for providing conditional probability modeling in accordance with some embodiments discussed herein. In some embodiments, the computing system 101 performs the conditional probability modeling associated with the dataflow diagram 500. The dataflow diagram 500 comprises a conditional probability model 502 that receives the set of binary indicator data structures 410a-n and generates an event score 504 based on the set of binary indicator data structures 410a-n.

In some embodiments, the computing system 101 may utilize respective labels of the set of binary indicator data structures 410a-n to perform the conditional probability modeling. For example, the set of binary indicator data structures 410a-n may be utilized as input for the conditional probability model 502. In some embodiments, a binary indicator data structure of the set of binary indicator data structures 410a-n is a data entity that groups time-based and entity-based labels for a subclass domain of the class domain 404. In some embodiments, an entity of a binary indicator data structure is associated with an entity identifier. An entity identifier is a data entity that identifies an entity associated with data from the entity data element set 402. In some embodiments, the entity identifier provides a link between various data points and/or attributes for an entity across different portions of the entity data element set 402. In a healthcare domain, the entity identifier may be a patient identifier that corresponds to a patient and/or patient information associated with one or more portions of the entity data element set 402. In some embodiments, the entity identifier enables accurate synthesis of data from multiple sources and/or optimized application of model parameters to input data for the conditional probability model 502. In some embodiments, the entity identifier enables formatting and/or configuration of input data for one or more modeling tasks associated with the conditional probability model 502.

In some embodiments, a binary indicator data structure of the set of binary indicator data structures 410a-n is generated based on a rules-based classification technique, one or more machine learning models (e.g., one or more classifier models), and/or another type of classification technique with respect to the entity data element set 402. In some embodiments, a binary indicator data structure of the set of binary indicator data structures 410a-n is a vectorized input for the conditional probability model 502. For example, a binary indicator data structure may comprise a vectorized representation of respective labels for respective timepoints of data extracted from one or more portions of the entity data element set 402 with a particular entity. In some embodiments, a binary indicator data structure is formatted and/or configured for a particular type of conditional probability model 502. In some embodiments, a binary indicator data structure of the set of binary indicator data structures 410a-n encapsulates various characteristics a subclass domain for an entity in a format suitable for computational analysis and modeling via the conditional probability model 502. In some embodiments, a binary indicator data structure may be configured to improve the performance of the via the conditional probability model 502.

The conditional probability model 502 may be a hardware and/or software architecture having one or more parameters and/or coefficients that define the architecture of the conditional probability model 502. In some embodiments, the one or more parameters and/or coefficients of the conditional probability model 502 are determined and/or tuned during configuration and/or training of the conditional probability model 502. In some examples, structural parameter(s) may define component(s) of the model's architecture and/or their configuration/order, such as, for example, the configuration/order specifying which output(s) of one component are provided as input to other component(s); a number, type, and/or configuration of component(s) per layer, a number of layers of the model, a type of estimation technique for the model, and/or the like. In some embodiments, the conditional probability model 502 is configured to utilize one or more modeling techniques, such as conditional probability modeling, classification modeling, etc. In some embodiments, the conditional probability model 502 is a machine learned model trained using one or more training techniques related to classification predictions, maximum likelihood estimation, Bayesian inferences, etc.

In some embodiments, the conditional probability model 502 is configured analyze relationships between events or patterns in data of the set of binary indicator data structures 410a-n. In some embodiments, the conditional probability model 502 utilizes a statistical approach to calculates the probability of an event occurring given that another event or condition has occurred. In some embodiments, the conditional probability model 502 may be utilized to estimate the probability of reducing a particular medical event (e.g., one or more inpatient admissions) given that a patient has been adequately medicated for a particular medical condition.

In some embodiments, a probability provided by the conditional probability model 502 may correspond to the following conditional probability:

$$P ( A / B ) = P ( A ⋂ B ) / P ( B )$$

$$P ( i ( t ) = 1 \vert s ( t ) = 1 ) = P ( i ( t ) = 1 \& s ( t ) = 1 ) / P ( s ( t ) = 1 )$$

where i(t) is a first binary indicator data structure of the set of binary indicator data structures 410a-n, s(t) is a second binary indicator data structure of the set of binary indicator data structures 410a-n, a(t) is a first binary indicator data structure of the set of binary indicator data structures 410a-n, and P(i(t)=1 & s(t)=1) is the probability of a particular defined event. In some embodiments, the probability of a particular defined event may provide: P(i(t)=1|s(t)=1)=Σi(t) s(t) a(t)/Σa(t)/Σs(t) a(t)/Σa(t)=Σi(t) s(t) a(t)/Σs(t) a(t).

In some embodiments, the event score 504 corresponds to an event score for a defined event associated with the entity group 406. In some embodiments, the event score 504 corresponds to a probability of the defined event for the entity group 406. In some embodiments, the event score 504 may be a reward score for a defined event. In some embodiments, the event score 504 may be a data entity that describes a binary and/or probabilistic measure of a likelihood that a defined probability classification will satisfy prediction criteria for the defined event. The event score 504 may comprise a real number, percentage, ratio, and/or any other likelihood representation. In some embodiments, the event score 504 may comprise a calculated probability, likelihood, or reward score associated with a specific outcome or event of interest for the entity group 406. For example, the event score 504 may refer to a probability of a particular medical event for the entity group 406, such as the probability of a reduction in inpatient admission given certain conditions associated with the entity group 406.

In some embodiments, the computing system 101 initiates the performance of a prediction-based action associated with the defined event based on the event score 504. In some embodiments, the computing system 101 may initiate presentation of a user interface element via a user interface based on the event score 504. In some embodiments, the computing system 101 may initiate transmission of a response to a query for a user interface based on the event score 504. For example, the prediction-based action may comprise real-time configuration of a user interface based on the event score 504 to enable a user to consume visual data and/or related insights associated with the entity group 406 in an interactive manner, where the visual data is tailored based on the event score 504. In another example, the prediction-based action may comprise an automated drug manufacturing, routing, and/or storage action. For instance, responsive to the event score 504, the computing system 101 may provide one or more instructions to a resource manufacturing device (e.g., a pharmaceutical manufacturing device, etc.) to cause a development and/or deployment of one or more resources (e.g., one or more pharmaceutical resources, one or more hospital resources, one or more medications, etc.). In some embodiments, the optimization model is a machine-learned model that is executed based on the event score 504. In some embodiments, the computing system 101 initiates the performance of the prediction-based action responsive to the event score 504 meeting or exceeding a threshold. In some embodiments, the computing system 101 generates the event score 504 responsive to a request from a user that identifies the class domain 404 and/or the interval of time for labels of the set of binary indicator data structures 410a-n. In some embodiments, the user interface comprises a prompt interface that enables a user to interact with the computing system 101 in an interactive and/or conversational manner.

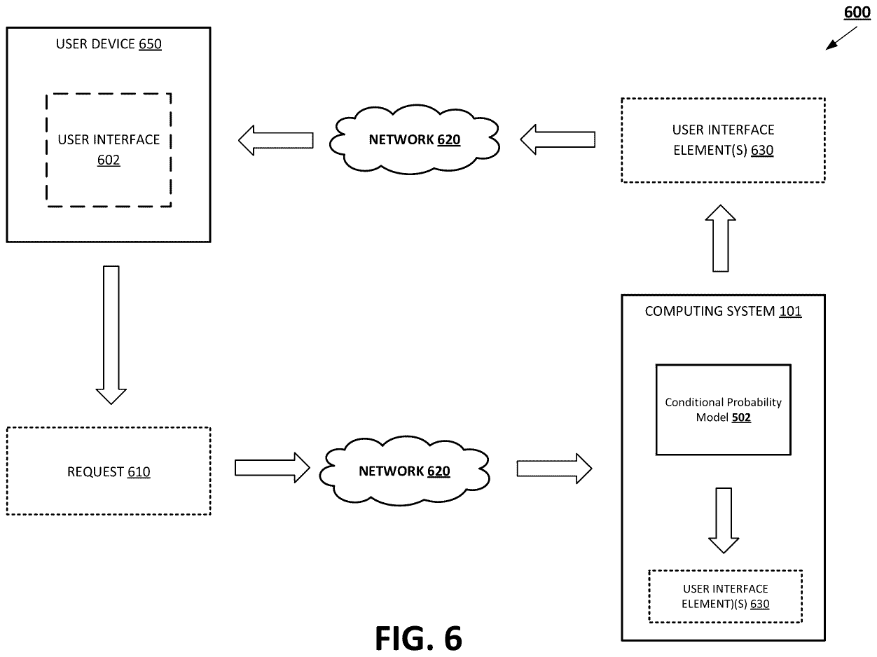

FIG. 6 depicts an interactive visualization system 600 showing example devices, systems, engines, data structures, and/or processes for generating one or more user interface elements for rendering via a user interface in accordance with some embodiments discussed herein. In some embodiments, the interactive visualization system 600 may enable real-time configuration of a user interface based on the event score 504. The interactive visualization system 600 may further enable a user to consume visual data and/or related insights associated with the entity group 406 in an interactive manner, where the visual data is tailored based on the event score 504.

In some embodiments, the interactive visualization system 600 comprises a user interface 602 of a user device 650. The user interface 602 may be an electronic interface for a web page, a mobile application, an electronic portal, a chatbot (e.g., an LLM-based chatbot), and/or the like. Additionally, a request 610 associated with the user interface 602 may be generated by the user device 650. For example, the request 610 may be a user interface request. In some embodiments, the request 610 may a query provided to a large language model. In some embodiments, the user device 650 may transmit the request 610 to the computing system 101 via a network 620. The network 620 may be configured based on one or more wired and/or wireless communication protocols. For example, the network 620 may provide communication executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. In addition, or alternatively, the predictive computing entity 106 may be configured to communicate via wireless external communication using any of a variety of protocols, as further disclosed herein.

In some embodiments, the request 610 comprises character-level text input associated with a structured and/or natural language sequence of text (e.g., one or more alphanumeric characters, symbols, etc.). In some examples, the character-level text input may comprise user input, such as text input and/or text generated from one or more audio, tactile, and/or like inputs related to the user interface 602. In some examples, the character-level text input may comprise a natural language sequence of text provided via the user interface 602. In some examples, character-level text input may comprise a natural language sequence of text that expresses a question, preference, and/or the like. In addition or alternatively, the character-level text input may indicate a class domain (e.g., the class domain 404) and/or an interval of time for labels of one or more binary indicator data structures (e.g., the set of binary indicator data structures 410a-n).

In some embodiments, the request 610 may comprise or otherwise be associated with one or more request attributes such as a location attribute (e.g., a GPS position, a latitude/longitude, etc.) and/or the like. For example, the one or more request attributes may comprise user location data. The user location data may comprise a real-time location approximation associated with the user device 650, data (e.g., a GPS position, a latitude/longitude, etc.) provided by a location module of the user device 650, data associated with a network connection (e.g., a 5G connection, an internet protocol (IP) address, etc.) associated with the user device 650, data based on location text input provided by a user via the user interface 602, a geofence location associated with the user device 650, and/or other location data associated with the user device 650.

In some embodiments, the user location data comprises location information (e.g., a GPS position, a latitude/longitude, an address, a geofence location, etc.) associated with a user device and/or a user identifier. In some embodiments, the user location data is based on a location module of the user device. The location module may be adapted to acquire, for example, latitude, longitude, altitude, geocode, course, direction, heading, speed, UTC, date, and/or various other information/data. In one embodiment, the location module may acquire data, such as ephemeris data, by identifying the number of satellites in view and the relative positions of those satellites (e.g., using GPS). The satellites may be a variety of different satellites, comprising LEO satellite systems, DOD satellite systems, the European Union Galileo positioning systems, the Chinese Compass navigation systems, Indian Regional Navigational satellite systems, and/or the like. This data may be collected using a variety of coordinate systems, such as the DD; DMS; UTM; UPS coordinate systems; and/or the like. Alternatively, the location information/data may be determined by triangulating a position of the user device in connection with a variety of other systems, comprising cellular towers, Wi-Fi access points, and/or the like. In some embodiments, the location module may use various position or location technologies comprising RFID tags, indoor beacons or transmitters, Wi-Fi access points, cellular towers, nearby computing devices (e.g., smartphones, laptops), and/or the like. For instance, such technologies may comprise the iBeacons, Gimbal proximity beacons, BLE transmitters, NFC transmitters, and/or the like.

In some embodiments, the computing system 101 receives the request 610 via the network 620. In some embodiments, the computing system 101 utilizes the conditional probability model 502 to generate one or more user interface elements 630. In some embodiments, responsive to the request 610, the computing system 101 may initiate presentation of the one or more user interface elements 630 via the user interface 602. For example, the computing system 101 may initiate presentation of the one or more user interface elements 630 in real time or at least approximately in real time as compared to the request 610 being generated via the user interface 602 and/or received by the computing system 101. In some embodiments, the one or more user interface elements 630 may comprise a query response for the request 610. In some embodiments, the request 610 is a first request and the computing system 101 may receive a second request that identifies a particular subclass domain for the entity group. In some embodiments, the computing system 101 may generate a particular binary indicator data structure for the set of binary indicator data structures 410a-n based on the particular subclass domain.

In some embodiments, the one or more user interface elements 630 may be formatted to provide a visualization and/or human interpretation of data via the user interface 602. In some embodiments, the one or more user interface elements 630 and/or one or more computer-executable instructions associated therewith may be formatted for transmission via the network 620. For example, the one or more user interface elements 630 may be formatted for transmission via an API, a communication channel, a communication interface, or combinations thereof. In one or more embodiments, the one or more user interface elements 630 may be interacted with via the user interface 602.

In some embodiments, the computing system 101 transmits the one or more user interface elements 630 to the user device 650 via the network 620. In some embodiments, the computing system 101 initiates a rendering of the one or more user interface elements 630 via the user interface 602 of the user device 650. In some embodiments, the one or more user interface elements 630 may be correlated to one or more other user interface elements displayed via the user interface 602. In some embodiments, an arrangement of the one or more user interface elements 630 may be optimally organized and/or presented via the user interface 602 to reduce a number of computing resources utilized by the user device 650 for interacting with the one or more user interface elements 630. As such, an efficient and cost-effective user interface visualization may be provided for the user device 650 by utilizing the computing system 101.

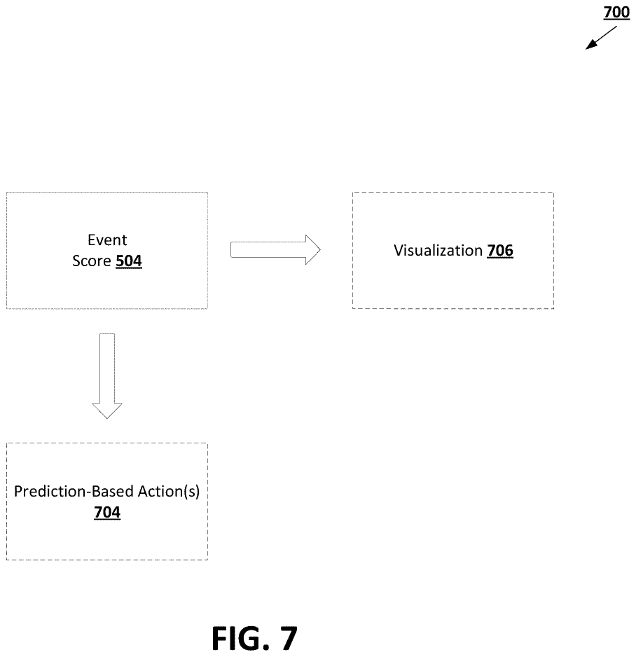

FIG. 7 depicts an example system 700 for providing prediction-based actions and/or visualizations, in accordance with one or more embodiments of the present disclosure. The system 700 comprises the event score 504 provided by the conditional probability model 502. In one or more embodiments, one or more prediction-based actions 704 are performed based on the event score 504. For example, the performance of the one or more prediction-based actions 704 may be initiated based on the event score 504. In some embodiments, the performance of the one or more prediction-based actions 704 may be initiated via an optimization model. For example, in some embodiments, the performance of the one or more prediction-based actions 704 may be initiated via a predictive machine learned model that is trained for a different predictive task than the conditional probability model 502. In some embodiments, data associated with the event score 504 may be stored in a storage system, such as the volatile memory 215, the non-volatile memory 210, the volatile memory 322, or the non-volatile memory 324. The data stored in the storage system may be employed for providing user interface renderings, graphical visualizations, machine learning, recommendations, reporting, decision-making purposes, operations management, healthcare management, configuring a resource manufacturing device, and/or other purposes. In certain embodiments, the data stored in the storage system may be employed to provide one or more insights to assist with healthcare decision making processes, such as, medical decisions for a patient. In addition or alternatively, one or more machine learned models may be retrained based on one or more features associated with the event score 504. For example, one or more relationships between features mapped in a machine learned model may be adjusted (e.g., refitted, tuned, etc.) based on data associated with the event score 504. In another example, cross-validation, hyperparameter optimization, and/or regularization associated with a machine learned model may be adjusted based on one or more features associated with the event score 504. In addition or alternatively, a visualization 706 may be generated based on the event score 504. The visualization 706 may comprise, for example, one or more interactive graphical elements for a user interface (e.g., the user interface 602) based on the event score 504.

In some embodiments, the one or more prediction-based actions 704 may comprise automated user interface actions, automated alerts, automated instructions to user devices, and/or automated adjustments to allocations of computing resources. Further, the one or more prediction-based actions 704 may comprise automated physician notification actions, automated patient notification actions, automated appointment scheduling actions, automated prescription recommendation actions, automated record updating actions, automated datastore updating actions, automated workforce management operational management actions, automated server load balancing actions, automated resource allocation actions, automated pricing actions, automated plan update actions, automated alert generation actions, generating one or more electronic communications, and/or the like. The one or more prediction-based actions 704 may further comprise displaying visual renderings of the aforementioned examples of prediction-based actions in addition to values, charts, and representations associated with the one or more policy scores and the prediction output using a prediction output user interface such as the visualization 706.

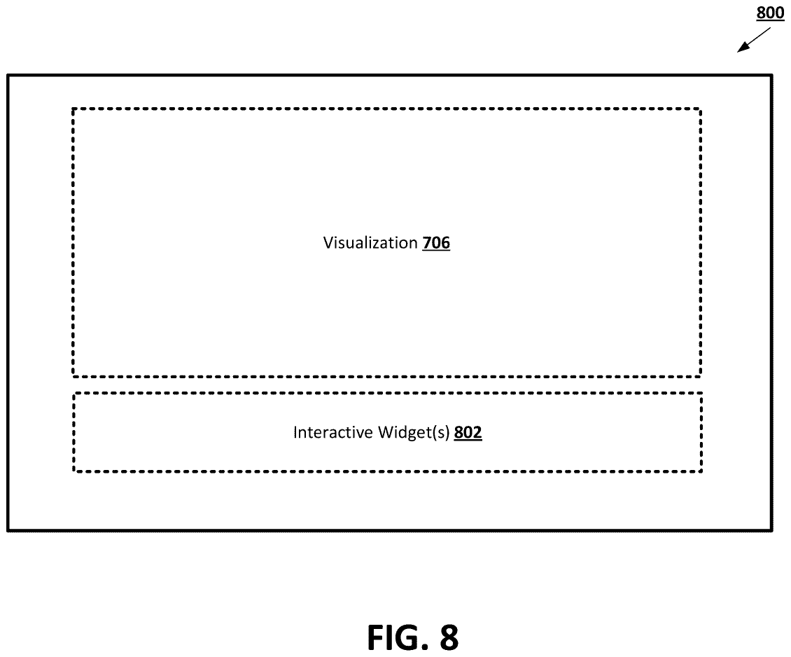

FIG. 8 depicts an example user interface 800, in accordance with one or more embodiments of the present disclosure. In one or more embodiments, the user interface 800 is, for example, an electronic interface (e.g., a graphical user interface) of the client computing entity 102. In some embodiments, the user interface 800 may be provided via the output device 316 of the client computing entity 102. In some embodiments, the user interface 800 may correspond to the user interface 602. In some embodiments, the user interface 800 is an electronic interface that provides a display and/or a visualization to a user via a user computing device. In some embodiments, the user interface 800 provides a GUI and/or associated GUI wizard (e.g., executable code configured to control a functionality of GUI) that provides one or more interactive interface screens, representations, and/or widgets for interacting with a user. The user interface 800 may be configured to provide, for display to a user, a visualization associated with the event score 504. In some embodiments, the user interface 800 is configured to render an interactive visualization associated with the event score 504. For example, the user interface 800 may be configured to render the visualization 706. In addition or alternatively, the user interface 800 may be configured to render one or more interactive widgets 802.

In various embodiments, the visualization 706 may provide an interactive visualization associated with the event score 504 to initiate a rendering of a script and/or execution of one or more instruction sets associated with a visualization. In some embodiments, the one or more interactive widgets 802 may be configured to receive user input to generate a request (e.g., the request 610). In various embodiments, the user interface 800 may be configured as a web portal interface (e.g., a medical provider portal, etc.) for managing data insights, allocation of resources, and/or a resource manufacturing device. In some embodiments, a user interaction with a particular widget of the one or more interactive widgets 802 may result in rendering of a new interactive widget and/or a new user interface. In some embodiments, the visualization 806 rendered via the user interface 800 may provide a rendering of a visualization associated with training dataset and/or configuration parameters during training and/or configuration of the conditional probability model 502. In some embodiments, one or more portions of the conditional probability model 502 may be configured based on a user interaction with respect to the visualization 706 and/or the one or more interactive widgets 802.

In some embodiments, the visualization 806 is configured to render one or more graphical elements associated with the event score 504. A graphical element may be a formatted version of one or more data objects to provide a visualization and/or human interpretation of data via the user interface 800. In some embodiments, a graphical element is formatted for transmission via a network (e.g., the network 720), an API, a communication channel, a communication interface, the like, or combinations thereof. In one or more embodiments, a graphical element comprises one or more graphical elements and/or one or more textual elements that may be selectable and/or otherwise interacted with via the user interface 800.

In some embodiments, the user interface 800 is configured to provide visual data for a script associated with one or more prompts with respect to the user interface 800. In some embodiments, a visualization associated with a script may be arranged relative to the one or more interactive widgets 802 to enable user input with respect to the script. In some embodiments, the one or more interactive widgets 802 enable a real-time workflow associated with a script. In this manner, the user interface 800 may provide an interface between a user and a platform that enables a user to selectively a contribute to the real-time workflow associated with a script. In some embodiments, the user interface 800 is configured to provide interaction with a large language model via one or more prompts and/or prompt responses provided via the one or more interactive widgets 802.

The user interface 800 may be specially configured to reduce the time, burden, and processing resources traditionally expended to ingest data from a plurality of data sources and/or the conditional probability model 502. To do so, the user interface 800 may arrange an interactive representation relative to an optimal configuration of representations and corresponding interactive widgets 802. The interactive representation and/or the one or more interactive widgets 802 may be arranged to accommodate small screen sizes, such as mobile devices, laptops, etc., without reducing the efficacy of a reviewing process. This, in turn, allows the performance of traditionally complex data matching operations from a client device with small form factors.

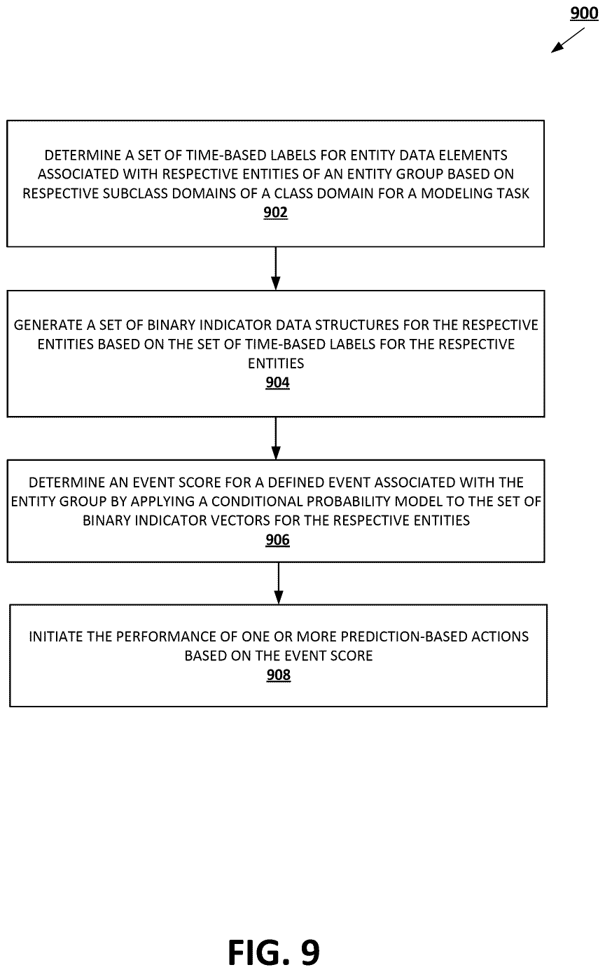

FIG. 9 depicts a flowchart diagram of an example process 900 for implementing conditional probability modeling in accordance with some embodiments discussed herein. The process 900 may be executed by one or more computing devices, entities, and/or systems (e.g., the computing system 101 and/or the predictive computing entity 106) described herein. For example, via the various steps/operations of the process 900, the computing system 101 may leverage improved data pre-processing and/or modeling techniques to optimize an input dataset for a conditional probability model. By doing so, the process 900 enables improved prediction-based actions related to a defined modeling task, while ensuring data quality and/or optimized computing resources in view of various data processing and/or modeling rules.

FIG. 9 illustrates an example process 900 for explanatory purposes. Although the example process 900 depicts a particular sequence of steps/operations, the sequence may be altered without departing from the scope of the present disclosure. For example, some of the steps/operations depicted may be performed in parallel or in a different sequence that does not materially impact the function of the process 900. In other examples, different components of an example device or system that implements the process 900 may perform functions at substantially the same time or in a specific sequence.

In some embodiments, the process 900 comprises, at step/operation 902, determining a set of time-based labels for entity data elements associated with respective entities of an entity group based on respective subclass domains of a class domain for a modeling task. For example, the computing system 101 may receive a request that identifies a class domain for an entity group. Additionally, the computing system 101 may identify a subset of the entity group that satisfies defined criterion associated with the class domain and an interval of time. The computing system 101 may then generate respective label sets associated with an entity of the entity group, respective timepoints of the interval of time, and a subclass domain of the class domain. In some embodiments, the request is generated responsive to user input via a user interface of a client device. In some embodiments, the user input identifies the class domain and the interval of time. In some embodiments, the request is a query provided to a large language model. In some embodiments, the request is a first request and the computing system 101 may receive a second request that identifies a particular subclass domain for the entity group. In some embodiments, the computing system 101 may generate a binary indicator data structure for the set of binary indicator data structures based on the particular subclass domain. In some embodiments, the computing system 101 may determine the entity group based on a clustering model associated with a set of similarity rules for the entity group.

In some embodiments, the process 900 comprises, at step/operation 904, generating a set of binary indicator data structures for the respective entities based on the set of time-based labels for the respective entities. For example, the computing system 101 may determine a set of binary indicator data structures for respective entities of the subset based on the class domain and an entity data element set for the respective entities. The set of binary indicator data structures may respectively comprise a label set associated with (i) an entity of the entity group, (ii) respective timepoints of the interval of time, (iii) and a subclass domain of the class domain. In some embodiments, the computing system 101 may generate a first binary indicator data structure associated with a first type of event within the entity data element set, a second binary indicator data structure associated with a second type of event within the entity data element set, and/or a third binary indicator data structure associated with a third type of event within the entity data element set.

In some embodiments, the process 900 comprises, at step/operation 906, determining an event score for a defined event associated with the entity group by applying a conditional probability model to the set of binary indicator vectors for the respective entities. For example, the computing system 101 may apply a conditional probability model to the set of binary indicator vectors to determine an event score for a defined event associated with the entity group.

In some embodiments, the process 900 comprises, at step/operation 908, initiating the performance of one or more prediction-based actions based on the event score. For example, the computing system 101 may initiate the performance of a prediction-based action associated with the defined event based on the event score. In some embodiments, the computing system 101 may initiate presentation of a user interface element via the user interface based on the event score. In some embodiments, the computing system 101 may initiate transmission of a response to a query for a user interface based on the event score.

Some techniques of the present disclosure enable the generation of action outputs that may be performed to initiate one or more real world actions to achieve real-world effects. The modeling techniques of the present disclosure may be used, applied, and/or otherwise leveraged to augment a user interface, which may help in the creation and provisioning of messages across computing entities, as well as other downstream tasks such as rendering of a visualization via a user interface. For instance, generative output, using some of the techniques of the present disclosure, may trigger the performance of actions at a client device, such as the display, transmission, and/or the like of data reflective of a visualization. In some embodiments, the visualization may trigger an alert via a user interface.

In some examples, the computing tasks may comprise actions that may be based on a defined domain task. A defined domain task may comprise any environment in which computing systems may be applied to generate a visualization and initiate the performance of computing tasks responsive to a visualization. These actions may cause real-world changes, for example, by controlling a hardware component of a user device or a server device, providing alerts, interactive actions, and/or the like. For instance, actions may comprise the initiation of automated instructions across and between devices, automated notifications, automated scheduling operations, automated precautionary actions, automated security actions, automated data processing actions, and/or the like.

In some embodiments, an action (e.g., a prediction-based action) comprises real-time configuration of a user interface based on the event score to enable a user to consume visual data associated with the geographic location in an interactive manner, where the visual data is tailored based on the event score. In some embodiments, an action (e.g., a prediction-based action) comprises an automated drug manufacturing, routing, and/or storage action. For instance, responsive to event score, the computing system 101 may provide one or more instructions to a resource manufacturing device (e.g., a pharmaceutical manufacturing device, etc.) to cause a development of one or more resources (e.g., one or more pharmaceutical resources, one or more hospital resources, one or more medications, etc.).

### IV. Conclusion

Throughout this specification, components, operations, or structures described as a single instance may be implemented as multiple instances. Although individual operations of one or more methods (or processes, techniques, routines, etc.) are illustrated and described as separate operations, two or more of the individual operations may be performed concurrently or otherwise in parallel, and nothing requires that the operations be performed in the order illustrated. Structures and functionality (e.g., operations, steps, blocks) presented as separate components in example configurations may be implemented as a combined structure, functionality, or component. Similarly, structures and functionality presented as a single component may be implemented as separate components. These and other variations, modifications, additions, and improvements fall within the scope of the subject matter herein.

Certain embodiments are described herein as comprising logic or a number of routines, subroutines, applications, operations, blocks, or instructions. These may constitute and/or be implemented by software (e.g., code embodied on a non-transitory, machine-readable medium), hardware, or a combination thereof. In hardware, the routines, etc., may represent tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware component that operates to perform certain operations as described herein.

In various embodiments, a hardware component may be implemented mechanically or electronically. For example, a hardware component may comprise dedicated circuitry or logic that is permanently configured (e.g., as a special-purpose processor, such as a field programmable gate array (FPGA) or an application-specific integrated circuit (ASIC)) to perform certain operations. A hardware component may also or instead comprise programmable logic or circuitry (e.g., as encompassed within one or more general-purpose processors and/or other programmable processor(s)) that is temporarily configured by software to perform certain operations.

Accordingly, the term “hardware component” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where the hardware components comprise a general-purpose processor configured using software, the general-purpose processor may be configured as respective different hardware components at different times. Software may accordingly configure a processor, for example, to constitute a particular hardware component at one instance of time and to constitute a different hardware component at a different instance of time.

Hardware components may provide information to, and receive information from, other hardware components. Accordingly, the described hardware components may be regarded as being communicatively coupled. Where multiple of such hardware components exist contemporaneously, communications may be achieved through signal transmission (e.g., over appropriate circuits and buses) that connect the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and may operate on a resource (e.g., a collection of information).

As noted above, the various operations of example methods (or processes, techniques, routines, etc.) described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions. The components referred to herein may, in some example embodiments, comprise processor-implemented components.

Moreover, each operation of processes illustrated as logical flow graphs may represent a sequence of operations that may be implemented in hardware, software, or a combination thereof. In the context of software, the operations represent computer-executable instructions stored on one or more computer-readable storage media that, when executed by one or more processors, perform the recited operations. Generally, computer-executable instructions comprise routines, programs, objects, components, data structures, and the like that perform particular functions or implement particular data types. The order in which the operations are described is not intended to be construed as a limitation, and any number of the described operations may be combined in any order and/or in parallel to implement the processes.

The terms “coupled” and “connected,” along with their derivatives, may be used. In particular embodiments, “connected” may be used to indicate that two or more elements are in direct physical or electrical contact with each other, although the context in the description may dictate otherwise when it is apparent that two or more elements are not in direct physical or electrical contact. “Coupled” may mean that two or more elements are in direct physical or electrical contact. However, “coupled” may also mean that two or more elements are not in direct contact with each other, yet still co-operate, transmit between, or interact with each other.

An algorithm may be considered to be a self-consistent sequence of acts or operations leading to a desired result. These comprise physical manipulations of physical quantities. Usually, though not necessarily, these quantities take the form of electrical, magnetic, or optical signals capable of being stored, transferred, combined, compared, and otherwise manipulated. These signals are commonly referred to as bits, values, elements, symbols, characters, terms, numbers, flags, or the like. It should be understood, however, that all of these and similar terms are to be associated with the appropriate physical quantities and are merely convenient labels applied to these quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “some embodiments,” “one embodiment,” “an embodiment,” “in some examples,” or variations thereof means that a particular element, feature, structure, characteristic, operation, or the like described in connection with the embodiment is comprised in at least one embodiment, but not every embodiment necessarily comprises the particular element, feature, structure, characteristic, operation, or the like. Different instances of such a reference in various places in the specification do not necessarily all refer to the same embodiment, although they may in some cases. Moreover, different instances of such a reference may describe elements, features, structures, characteristics, operations, or the like be combined in any manner as an embodiment.

As used herein, the terms “comprises,” “comprising,” “comprises,” “including,” “has,” “having” or any other variation thereof, are intended to cover a non-exclusive inclusion. For example, a process, method, article, or apparatus that comprises a list of elements is not necessarily limited to only those elements but may comprise other elements not expressly listed or inherent to such process, method, article, or apparatus. Further, unless the context of use clearly indicates otherwise, “or” refers to an inclusive or and not to an exclusive or. For example, a condition A or B is satisfied by any one of the following: A is true (or present) and B is false (or not present), A is false (or not present) and B is true (or present), and both A and B are true (or present).

The term “set” is intended to mean a collection of elements and may be a null set (i.e., a set containing zero elements) or may comprise one, two, or more elements. A “subset” is intended to mean a collection of elements that are all elements of a set, but that does not comprise other elements of the set. A first subset of a set may comprise zero, one, or more elements that are also elements of a second subset of the set. The first subset may be said to be a subset of the second subset if all the elements of the first subset are elements of the second subset, while also being a subset of the set. However, if all the elements of the second subset are also elements of the first subset (in addition to all the elements of the first subset being elements of the second subset), the first subset and the second subset are a single subset/not distinct.

For the purposes of the present disclosure, the term “a” or “an” entity refers to one or more of that entity. As such, the terms “a” or “an”, “one or more”, and “at least one” may be used interchangeably herein unless explicitly contradicted by the specification using the word “only one” or similar. For example, “a first element” may functionally be interpreted as “a first one or more elements” or a “first at least one element.” Unless otherwise apparent from the context of use, reference in the present disclosure to a same set of “one or more processors” (or a same “plurality of processors,” etc.) performing multiple operations may encompass implementations in which performance of the operations is divided among the processor(s) in any suitable way. For example, “generating, by one or more processors, X; and generating, by the one or more processors, Y” may encompass: (1) implementations in which a first subset of the processors (e.g., in a first computing device) generates X and an entirely distinct, second subset of the processors (e.g., in a different, second computing device) independently generates Y; (2) implementations in which one or more or all of the processor(s) (e.g., one or multiple processors in the same device, or multiple processors distributed among multiple devices) contribute to the generation of X and/or Y; and (3) other variations. This may similarly be applied to any other component or feature similarly recited (e.g., as “a component”, “a feature”, “one or more components”, “one or more features”, “a plurality of components”, “a plurality of features”). Moreover, the performance of certain of the operations may be distributed among the one or more components, not only residing within a single machine, but deployed across a number of machines. The set of components may be located in a single geographic location (e.g., within a home environment, an office environment, a cloud environment). In other example embodiments, the set of components may be distributed across two or more geographic locations. Further, “a machine-learned model”, equivalent terms (e.g., “machine learning model,” “machine-learning model,” “machine-learned component”, “artificial intelligence”, “artificial intelligence component”), or species thereof (e.g., “a large language model”, “a neural network”) may comprise a single machine-learned model or multiple machine-learned models, such as a pipeline comprising two or more machine-learned models arranged in series and/or parallel, an agentic framework of machine-learned models, or the like.

An “artificial intelligence” or “artificial intelligence component” may comprise a machine-learned model. A machine-learned model may comprise a hardware and/or software architecture having structural hyperparameters defining the model's architecture and/or one or more parameters (e.g., coefficient(s), weight(s), biase(s), activation function(s) and/or action function type(s) in examples where the activation function and/or function type is determined as part of training, clustering centroid(s)/medoid(s), partition(s), number of trees, tree depth, split parameters) determined as a result of training the machine-learned model based at least in part on training hyperparameters (e.g., for supervised, semi-supervised, and reinforcement learning models) and/or by iteratively operating the machine-learned model according to the training hyperparameters (e.g., for unsupervised machine-learned models).

In some examples, structural hyperparameter(s) may define component(s) of the model's architecture and/or their configuration/order, such as the configuration/order specifying which input(s) are provided to one component and which output(s) of that component are provided as input to other component(s) of the machine-learned model; a number, type, and/or configuration of component(s) per layer; a number of layers of the model; a number and/or type of input nodes in an input layer of the model; a number and/or type of nodes in a layer; a number and/or type of output nodes of an output layer of the model; component dimension (e.g., input size versus output size); a number of trees; a maximum tree depth; node split parameters; minimum number of samples in a leaf node of a tree; and/or the like. The component(s) of the model may comprise one or more activation functions and/or activation function type(s) (e.g., gated linear unit (GLU), such as a rectified linear unit (ReLU), leaky RELU, Gaussian error linear unit (GELU), Swish, hyperbolic tangent), one or more attention mechanism and/or attention mechanism types (e.g., self-attention, cross-attention), nodes and split indications and/or probabilities in a decision tree, and/or various other component(s) (e.g., adding and/or normalization layer, pooling layer, filter). Various combinations of any these components (as defined by the structural hyperparameter(s)) may result in different types of model architectures, such as a transformer-based machine-learned model (e.g., encoder-only model(s), encoder-decoder model(s), decoder-only models, generative pre-trained transformer(s) (GPT(s))), neural network(s), multi-layer perceptron(s), Kolmogorov-Arnold network(s), clustering algorithm(s), support vector machine(s), gradient boosting machine(s), and/or the like. The structural parameters and components a machine-learned model comprises may vary depending on the type of machine-learned model.

Training hyperparameter(s) may be used as part of training or otherwise determining the machine-learned model. In some examples, the training hyperparameter(s), in addition to the training data and/or input data, may affect determining the parameter(s) of the target machine-learned model. Using a different set of training hyperparameters to train two machine-learned models that have the same architecture (i.e., the same structural hyperparameters) and using the same training data may result in the parameters of the first machine-learned model differing from the parameters of the second machine-learned model. Despite having the same architecture and having been trained using the same training data, such machine-learned models may generate different outputs from each other, given the same input data. Accordingly, accuracy, precision, recall, and/or bias may vary between such machine-learned models.

In some examples, training hyperparameter(s) may comprise a train-test split ratio, activation function and/or activation function type (e.g., in examples like Kolmogorov-Arnold networks (KANs) where the activation function type is determined as part of training from an available set of activation functions and/or limits on the activation function parameters specified by the training hyperparameters), training stage(s) (e.g., using a first set of hyperparameters for a first epoch of training, a second set of hyperparameters for a second epoch of training), a batch size and/or number of batches of data in a training epoch, a number of epochs of training, the loss function used (e.g., L1, L2, Huber, Cauchy, cross entropy), the component(s) of the machine-learned model that are altered using the loss for a particular batch or during a particular epoch of training (e.g., some components may be “frozen,” meaning their parameters are not altered based on the loss), learning rate, learning rate optimization algorithm type (e.g., gradient descent, adaptive, stochastic) used to determine an alteration to one or more parameters of one or more components of the machine-learned model to reduce the loss determined by the loss function, learning rate scheduling, and/or the like.

In some examples, the structural hyperparameters and/or the training hyperparameters may be determined by a hyperparameter optimization algorithm or based on user input, such as a software component written by a user or generated by a machine-learned model. The machine-learned model may comprise any type of model configured, trained, and/or the like to generate a prediction output for a model input. In some examples, any of the logic, component(s), routines, and/or the like discussed herein may be implemented as a machine-learned model.

The machine-learned model may comprise one or more of any type of machine-learned model including one or more supervised, unsupervised, semi-supervised, and/or reinforcement learning models. Training a machine-learned model may comprise altering one or more parameters of the machine-learned model (e.g., using a loss optimization algorithm) to reduce a loss. Depending on whether the machine-learned model is supervised, semi-supervised, unsupervised, etc. this loss may be determined based at least in part on a difference between an output generated by the model and ground truth data (e.g., a label, an indication of an outcome that resulted from a system using the output), a cost function, a fit of the parameter(s) to a set of data, a fit of an output to a set of data, and/or the like. In some examples, determining an output by a machine-learned model may comprise executing a set of inference operations executed by the machine-learned model according to the target machine-learned model's parameter(s) and structural hyperparameter(s) and using/operating on a set of input data.

Moreover, any discussion of receiving data associated with an individual that may be protected, confidential, or otherwise sensitive information, is understood to have been preceded by transmitting a notice of use of the data to a computing device, account, or other identifier (collectively, “identifier”) associated with the individual, receiving an indication of authorization to use the data from the identifier, and/or providing a mechanism by which a user may cause use of the data to cease or a copy of the data to be provided to the user.

Upon reading this disclosure, those of skill in the art will appreciate still additional alternative structural and functional designs through the principles disclosed herein. Therefore, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The patent claims at the end of this patent application are not intended to be construed under 35 U.S.C. § 112(f) unless traditional means-plus-function language is expressly recited, such as “means for” or “step for” language being explicitly recited in the claim(s).

### V. Examples

Some embodiments of the present disclosure may be implemented by one or more computing devices, entities, and/or systems described herein to perform one or more example operations, such as those outlined below. The examples are provided for explanatory purposes. Although the examples outline a particular sequence of steps/operations, each sequence may be altered without departing from the scope of the present disclosure. For example, some of the steps/operations may be performed in parallel or in a different sequence that does not materially impact the function of the various examples. In other examples, different components of an example device or system that implements a particular example may perform functions at substantially the same time or in a specific sequence.

Moreover, although the examples may outline a system or computing entity with respect to one or more steps/operations, each step/operation may be performed by any one or combination of computing devices, entities, and/or systems described herein. For example, a computing system may comprise a single computing entity that is configured to perform all of the steps/operations of a particular example. In addition, or alternatively, a computing system may comprise multiple dedicated computing entities that are respectively configured to perform one or more of the steps/operations of a particular example. By way of example, the multiple dedicated computing entities may coordinate to perform all of the steps/operations of a particular example.

Example 1. A computer-implemented method comprising: receiving, by the one or more processors, a request that identifies a class domain for an entity group; identifying, by the one or more processors, a subset of the entity group that satisfies defined criterion associated with the class domain and an interval of time; determining, by one or more processors, a set of binary indicator data structures for respective entities of the subset based on the class domain and an entity data element set for the respective entities, wherein the set of binary indicator data structures respectively comprise a label set associated with (i) an entity of the entity group, (ii) respective timepoints of the interval of time, (iii) and a subclass domain of the class domain; applying, by the one or more processors, a conditional probability model to the set of binary indicator vectors to determine an event score for a defined event associated with the entity group; and initiating, by the one or more processors, the performance of a prediction-based action associated with the defined event based on the event score

Example 2. The computer-implemented method of example 1, wherein determining the set of binary indicator data structures comprises: generating a first binary indicator data structure associated with a first type of event within the entity data element set; and generating a second binary indicator data structure associated with a second type of event within the entity data element set.

Example 3. The computer-implemented method of any of the above examples, wherein the request is generated responsive to user input via a user interface of a client device, and the computer-implemented method further comprising initiating presentation of a user interface element via the user interface based on the event score.

Example 4. The computer-implemented method of any of the above examples, wherein the user input identifies the class domain and the interval of time.

Example 5. The computer-implemented method of any of the above examples, wherein the request is a query provided to a large language model, and the computer-implemented method further comprising initiating transmission of a response for a user interface based on the event score.

Example 6. The computer-implemented method of any of the above examples, wherein the request is a first request, and the computer-implemented method further comprising: receiving a second request that identifies a particular subclass domain for the entity group; and generating a binary indicator data structure for the set of binary indicator data structures based on the particular subclass domain.

Example 7. The computer-implemented method of any of the above examples, further comprising: determining the entity group based on a clustering model associated with a set of similarity rules for the entity group.

Example 8. A system comprising: one or more processors; and one or more memories storing processor-executable instructions that, when executed by the one or more processors, cause the one or more processors to perform operations comprising: receiving a request that identifies a class domain for an entity group; identifying a subset of the entity group that satisfies defined criterion associated with the class domain and an interval of time; determining a set of binary indicator data structures for respective entities of the subset based on the class domain and an entity data element set for the respective entities, wherein the set of binary indicator data structures respectively comprise a label set associated with (i) an entity of the entity group, (ii) respective timepoints of the interval of time, (iii) and a subclass domain of the class domain; applying a conditional probability model to the set of binary indicator vectors to determine an event score for a defined event associated with the entity group; and initiating the performance of a prediction-based action associated with the defined event based on the event score.

Example 9. The system of example 8, wherein determining the set of binary indicator data structures comprises: generating a first binary indicator data structure associated with a first type of event within the entity data element set; and generating a second binary indicator data structure associated with a second type of event within the entity data element set.

Example 10. The system of any of the above examples, wherein the request is generated responsive to user input via a user interface of a client device, and the one or more processors further perform operations comprising initiating presentation of a user interface element via the user interface based on the event score.

Example 11. The system of any of the above examples, wherein the user input identifies the class domain and the interval of time.

Example 12. The system of any of the above examples, wherein the request is a query provided to a large language model, and the one or more processors further perform operations comprising initiating transmission of a response for a user interface based on the event score.

Example 13. The system of any of the above examples, wherein the request is a first request, and the one or more processors further perform operations comprising: receiving a second request that identifies a particular subclass domain for the entity group; and generating a binary indicator data structure for the set of binary indicator data structures based on the particular subclass domain.

Example 14. The system of any of the above examples, wherein the one or more processors further perform operations comprising: determining the entity group based on a clustering model associated with a set of similarity rules for the entity group.

Example 15. One or more non-transitory computer-readable media storing processor-executable instructions that, when executed by one or more processors, cause the one or more processors to perform operations comprising: receiving a request that identifies a class domain for an entity group; identifying a subset of the entity group that satisfies defined criterion associated with the class domain and an interval of time; determining a set of binary indicator data structures for respective entities of the subset based on the class domain and an entity data element set for the respective entities, wherein the set of binary indicator data structures respectively comprise a label set associated with (i) an entity of the entity group, (ii) respective timepoints of the interval of time, (iii) and a subclass domain of the class domain; applying a conditional probability model to the set of binary indicator vectors to determine an event score for a defined event associated with the entity group; and initiating the performance of a prediction-based action associated with the defined event based on the event score.

Example 16. The one or more non-transitory computer-readable media of example 15, wherein determining the set of binary indicator data structures comprises: generating a first binary indicator data structure associated with a first type of event within the entity data element set; and generating a second binary indicator data structure associated with a second type of event within the entity data element set.

Example 17. The one or more non-transitory computer-readable media of any of the above examples, wherein the request is generated responsive to user input via a user interface of a client device, and the instructions further cause the one or more processors to perform operations comprising initiating presentation of a user interface element via the user interface based on the event score.

Example 18. The one or more non-transitory computer-readable media of any of the above examples, wherein the user input identifies the class domain and the interval of time.

Example 19. The one or more non-transitory computer-readable media of any of the above examples, wherein the request is a query provided to a large language model, and the instructions further cause the one or more processors to perform operations comprising initiating transmission of a response for a user interface based on the event score.

Example 20. The one or more non-transitory computer-readable media of any of the above examples, wherein the request is a first request, and the instructions further cause the one or more processors to perform operations comprising: receiving a second request that identifies a particular subclass domain for the entity group; and generating a binary indicator data structure for the set of binary indicator data structures based on the particular subclass domain.

Example 21. The computer-implemented method of example 1, wherein the method further comprises training the conditional probability model.

Example 22. The computer-implemented method of example 21, wherein the training is performed by the one or more processors.

Example 23. The computer-implemented method of example 21, wherein the one or more processors are comprised in a first computing entity; and the training is performed by one or more other processors comprised in a second computing entity.

Example 24. The computing system of example 12, wherein the one or more processors are further configured to train the conditional probability model.

Example 25. The computing system of example 24, wherein the one or more processors are comprised in a first computing entity; and the conditional probability model is trained by one or more other processors comprised in a second computing entity.

Example 26. The one or more non-transitory computer-readable storage media of example 20, wherein the instructions further cause the one or more processors to train the conditional probability model.

Example 27. The one or more non-transitory computer-readable storage media of example 26, wherein the one or more processors are comprised in a first computing entity; and the conditional probability model is trained by one or more other processors comprised in a second computing entity.

1. A computer-implemented method comprising:
receiving, by the one or more processors, a request that identifies a class domain for an entity group;
identifying, by the one or more processors, a subset of the entity group that satisfies defined criterion associated with the class domain and an interval of time;
determining, by one or more processors, a set of binary indicator data structures for respective entities of the subset based on the class domain and an entity data element set for the respective entities, wherein the set of binary indicator data structures respectively comprise a label set associated with (i) an entity of the entity group, (ii) respective timepoints of the interval of time, (iii) and a subclass domain of the class domain;
applying, by the one or more processors, a conditional probability model to the set of binary indicator vectors to determine an event score for a defined event associated with the entity group; and
initiating, by the one or more processors, the performance of a prediction-based action associated with the defined event based on the event score.

2. The computer-implemented method of claim 1, wherein determining the set of binary indicator data structures comprises:
generating a first binary indicator data structure associated with a first type of event within the entity data element set; and
generating a second binary indicator data structure associated with a second type of event within the entity data element set.

3. The computer-implemented method of claim 1, wherein the request is generated responsive to user input via a user interface of a client device, and the computer-implemented method further comprising initiating presentation of a user interface element via the user interface based on the event score.

4. The computer-implemented method of claim 3, wherein the user input identifies the class domain and the interval of time.

5. The computer-implemented method of claim 1, wherein the request is a query provided to a large language model, and the computer-implemented method further comprising initiating transmission of a response for a user interface based on the event score.

6. The computer-implemented method of claim 1, wherein the request is a first request, and the computer-implemented method further comprising:
receiving a second request that identifies a particular subclass domain for the entity group; and
generating a binary indicator data structure for the set of binary indicator data structures based on the particular subclass domain.

7. The computer-implemented method of claim 1, further comprising:
determining the entity group based on a clustering model associated with a set of similarity rules for the entity group.

8. A system comprising:
one or more processors; and
one or more memories storing processor-executable instructions that, when executed by the one or more processors, cause the one or more processors to perform operations comprising:
receiving a request that identifies a class domain for an entity group;
identifying a subset of the entity group that satisfies defined criterion associated with the class domain and an interval of time;
determining a set of binary indicator data structures for respective entities of the subset based on the class domain and an entity data element set for the respective entities, wherein the set of binary indicator data structures respectively comprise a label set associated with (i) an entity of the entity group, (ii) respective timepoints of the interval of time, (iii) and a subclass domain of the class domain;
applying a conditional probability model to the set of binary indicator vectors to determine an event score for a defined event associated with the entity group; and
initiating the performance of a prediction-based action associated with the defined event based on the event score.

9. The system of claim 8, wherein determining the set of binary indicator data structures comprises:
generating a first binary indicator data structure associated with a first type of event within the entity data element set; and
generating a second binary indicator data structure associated with a second type of event within the entity data element set.

10. The system of claim 8, wherein the request is generated responsive to user input via a user interface of a client device, and the one or more processors further perform operations comprising initiating presentation of a user interface element via the user interface based on the event score.

11. The system of claim 10, wherein the user input identifies the class domain and the interval of time.

12. The system of claim 8, wherein the request is a query provided to a large language model, and the one or more processors further perform operations comprising initiating transmission of a response for a user interface based on the event score.

13. The system of claim 8, wherein the request is a first request, and the one or more processors further perform operations comprising:
receiving a second request that identifies a particular subclass domain for the entity group; and
generating a binary indicator data structure for the set of binary indicator data structures based on the particular subclass domain.

14. The system of claim 8, wherein the one or more processors further perform operations comprising:
determining the entity group based on a clustering model associated with a set of similarity rules for the entity group.

15. One or more non-transitory computer-readable media storing processor-executable instructions that, when executed by one or more processors, cause the one or more processors to perform operations comprising:
receiving a request that identifies a class domain for an entity group;
identifying a subset of the entity group that satisfies defined criterion associated with the class domain and an interval of time;
determining a set of binary indicator data structures for respective entities of the subset based on the class domain and an entity data element set for the respective entities, wherein the set of binary indicator data structures respectively comprise a label set associated with (i) an entity of the entity group, (ii) respective timepoints of the interval of time, (iii) and a subclass domain of the class domain;
applying a conditional probability model to the set of binary indicator vectors to determine an event score for a defined event associated with the entity group; and
initiating the performance of a prediction-based action associated with the defined event based on the event score.

16. The one or more non-transitory computer-readable media of claim 15, wherein determining the set of binary indicator data structures comprises:
generating a first binary indicator data structure associated with a first type of event within the entity data element set; and
generating a second binary indicator data structure associated with a second type of event within the entity data element set.

17. The one or more non-transitory computer-readable media of claim 15, wherein the request is generated responsive to user input via a user interface of a client device, and the instructions further cause the one or more processors to perform operations comprising initiating presentation of a user interface element via the user interface based on the event score.

18. The one or more non-transitory computer-readable media of claim 17, wherein the user input identifies the class domain and the interval of time.

19. The one or more non-transitory computer-readable media of claim 15, wherein the request is a query provided to a large language model, and the instructions further cause the one or more processors to perform operations comprising initiating transmission of a response for a user interface based on the event score.

20. The one or more non-transitory computer-readable media of claim 15, wherein the request is a first request, and the instructions further cause the one or more processors to perform operations comprising:
receiving a second request that identifies a particular subclass domain for the entity group; and
generating a binary indicator data structure for the set of binary indicator data structures based on the particular subclass domain.
